(19) United States
(12) Patent Application Publication
(10) Pub. No.: US 2010/0246348 A1
(43) Pub. Date: Sep. 30, 2010

(54) OPTICAL INFORMATION REPRODUCING METHOD, OPTICAL INFORMATION REPRODUCING APPARATUS, AND OPTICAL INFORMATION RECORDING MEDIUM

(75) Inventors: Yuichiro Yamamoto, Kanagawa-ken (JP); Chikara Tanioka, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/728,888

(22) Filed: Mar. 22, 2010

(30) Foreign Application Priority Data
Mar. 24, 2009 (JP) 2009-072881

(51) Int. Cl. G11B 20/00

(52) U.S. Cl. 369/47.15; G9B/20

(57) ABSTRACT

An optical information reproducing method includes: obtaining information about a wavelength of a reference beam at recording time from a recording medium which stores main information recorded as a pattern corresponding to interference between an information beam and the reference beam and information about the wavelength of the reference beam at the recording time; determining an aiming temperature, which is a temperature of the recording medium suited to reproduce the pattern; determining an aiming incident angle, which is an incident angle of the reference beam at the reproducing time suited to reproduce the pattern; controlling the temperature of the recording medium so that the temperature of the recording medium is generally equal to the aiming temperature; and controlling the incident angle of the reference beam at the reproducing time so that the incident angle of the reference beam at the reproducing time is generally equal to the aiming incident angle.

### CROSS-REFERENCE TO RELATED APPLICATIONS

This application is based upon and claims the benefit of priority from the prior Japanese Patent Application No. 2009-72881, filed on Mar. 24, 2009; the entire contents of which are incorporated herein by reference.

### BACKGROUND

1. Field

Embodiments of this invention relate generally to an optical information reproducing method, an optical information reproducing apparatus, and an optical information recording medium.

2. Background Art

Optical recording media such as optical discs for recording and reproducing information by light irradiation have such advantages as being more portable and inexpensive than HDD (hard disc drive), and have the advantage of enabling faster access than magnetic tapes. Hence, they are widely used as recording media in computer backup, image recording and reproduction for home use, in-car navigation systems, and the like.

Since the CD (Compact Disc) was first manufactured and commercialized in 1982, optical discs have increased in capacity in accordance with the development guideline primarily aiming at shorter laser wavelength and larger numerical aperture of the objective lens. Thus, the BD (Blu-ray Disc) based on a blue-violet semiconductor laser in the 405-nm wavelength band and an objective lens with a numerical aperture of 0.85 has been developed. However, with the advent of the BD, schemes based on the above development guideline are considered to be nearly reaching the limit. Major reasons for this are that at a wavelength of 400 nm or less, absorption of light in the disc substrate becomes prominent, decreasing the optical transmittance, and that the numerical aperture of the objective lens is close to 1, the physical limit.

Thus, toward the realization of the fourth-generation high-capacity optical storage (memory device) following the CD, DVD (Digital Versatile Disc), and BD, it is required to establish an innovative recording/reproducing scheme which breaks through the limits of the conventional schemes.

In this context, the “hologram recording/reproducing scheme” has drawn attention as a promising candidate.

The recording principle of the hologram recording/reproducing scheme is to allow an information beam and a reference beam, which are coherent and split from a laser light source, to interfere in a recording medium, thereby recording information three-dimensionally as a fine moire (interference pattern). In this scheme, a plurality of moires can be multiply recorded at the same area or overlapping areas of the recording medium. For instance, it is possible to achieve “angle-multiple recording” for multiple recording by varying the incident angle of light and “shift-multiple recording” for multiple recording by slightly (such as from approximately several μm to 10 μm) shifting recording locations.

On the other hand, in reproduction, the recording medium is irradiated with a reproduction illumination beam (e.g., the same beam as the reference beam), which is diffracted in accordance with the recorded interference pattern, and the diffracted beam is used for reproduction. For angle-multiple recording, different interference patterns can be reproduced by irradiating the same location of the recording medium with the reproduction illumination beam being varied in angle. For shift-multiple recording, overlapping interference patterns can be reproduced by irradiation with the reproduction illumination beam shifted by e.g. approximately 10 μm.

Thus, the hologram recording/reproducing scheme can achieve significantly higher capacity than current two-dimensional recording schemes for optical discs, where pits or marks are used to record information in a plane.

Application of the hologram recording/reproducing scheme to high-capacity optical storage was suggested soon after Dennis Gabor invented holography in 1948, which led to his acceptance of the Nobel Prize. However, it was not successfully commercialized because of immaturity in key components required for system construction and insufficient sensitivity and dynamic range of recording media.

However, in recent years, the technology level of the key components such as spacial light modulators and two-dimensional imaging devices has been dramatically increased. In addition, many of the optical engineers conventionally engaged in optical disc technology have moved into the field of holographic storage to advance feasibility verification. Hence, although some problems remain to be solved, commercialization of hologram recording/reproducing apparatuses and recording media and subsequent full-scale dissemination have become a real possibility.

Currently, photopolymers, having such advantages as being superior in sensitivity and inexpensive, are representative of the material for recording media applicable to hologram recording, and development toward higher sensitivity and increased multiplicity is being advanced using photopolymers.

Here, due to its large linear expansion coefficient, the photopolymer has the problem of degradation in the reproduced image when the hologram is reproduced at a temperature different from that at the recording time. This is pointed out, for instance, in Lisa Dhar, Melinda G. Schnoes, Theresa L. Wysocki, Harvey Bair, Marcia Schilling, and Carol Boyd, “Temperature-induced changes in photopolymer volume holograms”, Appl. Phys. Lett., Vol. 73, No. 10, 7 Sep. 1998, pp. 1337-1339.

In response to this problem, JP-A-2006-267554 proposes the following technique. At the time of recording on a hologram recording medium, the information of temperature sensed by a temperature sensing unit is recorded as header information on the hologram recording medium. At the reproducing time, the information of temperature is obtained from the header information of the hologram recording medium, and temperature sensed by the temperature sensing unit is obtained. The difference between the obtained temperatures is used to determine the shift amount of the reproduction wavelength for canceling the effect due to dimensional change between the recording time and reproducing time of the hologram recording medium to shift the oscillation wavelength of a wavelength-tunable laser. Thus, JP-A-2006-267554 affirms that it provides a hologram recording/reproducing apparatus which can eliminate the effect on reproduction caused by the dimensional change of the hologram recording medium due to temperature variation and the like. As described above, the technique of JP-A-2006-267554 attempts to solve the problem associated with temperature variation by adjusting the laser wavelength.

However, in order to appropriately reproduce the recorded information, the wavelength of the reproduction illumination beam needs to be adjusted in a wide range of several nanometers. In general, this complicates the mechanism and control. For instance, use of an external-resonator laser as disclosed in JP-A-2006-267554 needs sophisticated control for slightly varying the angle of a grating. This requires a technique in which, at the reproducing time, recorded information is favorably reproduced using a reproduction illumination beam with an arbitrary wavelength.

On the other hand, with regard to the problem associated with wavelength variation between the recording time and reproducing time, JP-A-2006-277873 proposes the following hologram recording/reproducing apparatus, and affirms that it can reproduce recorded information by reliably detecting the “return beam” (the light returning from the hologram recording medium irradiated with the reference beam at the reproducing time) even if the wavelength at the reproducing time is different from that at the recording time. More specifically, this apparatus comprises: a movable optical element capable of changing the incident angle of the reference beam with respect to the hologram recording medium; a movable optical element control device which, in recording a hologram on the hologram recording medium, moves the movable optical element so as to set the incident angle of the reference beam to a predetermined angle α, β, γ, and which, in reproducing the recorded information based on the hologram, moves the movable optical element so that the incident angle of the reference beam continuously changes within a predetermined angle range θ including the predetermined angle α, β, γ; and a reproduction device which receives from an optical detector a light receiving signal corresponding to the intensity of the return beam while the incident angle of the reference beam changes continuously, and which reproduces the recorded information on the basis of the light receiving signal at the time when the intensity is not lower than a predetermined level or is maximized.

However, JP-A-2006-277873 includes no description of the aforementioned problem associated with temperature variation.

### SUMMARY

According to an aspect of the invention, there is provided an optical information reproducing method including: obtaining information about a wavelength of a reference beam at recording time from a recording medium which stores main information recorded as a pattern corresponding to interference between an information beam and the reference beam and information about the wavelength of the reference beam at the recording time; determining an aiming temperature, which is a temperature of the recording medium suited to reproduce the pattern, on the basis of difference between the wavelength of the reference beam at the recording time and a wavelength of a reference beam at reproducing time; determining an aiming incident angle, which is an incident angle of the reference beam at the reproducing time suited to reproduce the pattern, on the basis of the difference between the wavelength of the reference beam at the recording time and the wavelength of the reference beam at the reproducing time; controlling the temperature of the recording medium so that the temperature of the recording medium is generally equal to the aiming temperature; and controlling the incident angle of the reference beam at the reproducing time so that the incident angle of the reference beam at the reproducing time is generally equal to the aiming incident angle.

According to another aspect of the invention, there is provided an optical information reproducing apparatus including: an information obtaining device configured to obtain information about a wavelength of a reference beam at recording time from a recording medium which stores main information recorded as a pattern corresponding to interference between an information beam and the reference beam by a main information recording device and information about the wavelength of the reference beam at the recording time recorded by a wavelength information recording device; a main information reproducing device configured to obtain the main information recorded on the recording medium by applying a reference beam at reproducing time; a temperature determination device configured to determine an aiming temperature, which is a temperature of the recording medium suited to reproduce the pattern, on the basis of difference between the wavelength of the reference beam at the recording time and the wavelength of the reference beam at the reproducing time; an incident angle determination device configured to determine an aiming incident angle, which is an incident angle of the reference beam at the reproducing time suited to reproduce the pattern, on the basis of the difference between the wavelength of the reference beam at the recording time and the wavelength of the reference beam at the reproducing time; a temperature control device configured to control the temperature of the recording medium so that the temperature of the recording medium is generally equal to the aiming temperature; and an incident angle control device configured to control the incident angle of the reference beam at the reproducing time so that the incident angle of the reference beam at the reproducing time is generally equal to the aiming incident angle.

According to another aspect of the invention, there is provided an optical information recording medium with data recorded thereon, the data including: main information recorded as a pattern corresponding to interference between an information beam and a reference beam; and information about a wavelength of the reference beam at recording of the main information.

### BRIEF DESCRIPTION OF THE DRAWINGS

FIG. 1 is a schematic cross-sectional view illustrating the operation at the recording time of a hologram recording/reproducing apparatus 2 according to an embodiment of the invention;

FIG. 2 is a schematic cross-sectional view illustrating the operation at the reproducing time of the hologram recording/reproducing apparatus 2 according to the embodiment of the invention;

FIGS. 3A to 3C are schematic views illustrating a recording medium 1 according to the embodiment of the invention;

FIGS. 4A to 4C are schematic views illustrating another recording medium 1 according to the embodiment of the invention;

FIG. 5 is a schematic perspective view illustrating a coordinate system used to describe the hologram recording/reproducing method according to this embodiment;

FIG. 6 is a block diagram illustrating the control aspect of the hologram recording apparatus 3 capable of recording;

FIG. 7 is a flow chart illustrating the operation of the hologram recording apparatus 3 capable of recording;

FIG. 8 is a block diagram illustrating the control aspect of the hologram reproducing apparatus 4 capable of reproducing;

FIG. 9 is a flow chart illustrating the operation of the hologram reproducing apparatus 4 capable of reproducing;

FIG. 10 is a schematic cross-sectional view for describing parameters used in the method for determining the temperature difference ΔT and the angle difference Δθ_{y};

FIGS. 11A to 11C show schematic graphs for conceptually describing the hologram reproducing method according to this embodiment;

FIG. 12 is a schematic cross-sectional view showing an optical system used in this analysis example;

FIG. 13 is a schematic cross-sectional view illustrating the operation at the recording time of the hologram recording/reproducing apparatus 7 according to the comparative example;

FIG. 14 is a schematic cross-sectional view illustrating the operation at the reproducing time of the hologram recording/reproducing apparatus 7 according to the comparative example

FIGS. 15A to 15C are schematic views showing the analysis result of reproduced images in the case of using the apparatus 7 according to the comparative example; and

FIGS. 16A to 16G are schematic views showing the analysis results in the comparative example and the practical example.

### DETAILED DESCRIPTION

Embodiments of the invention will now be described with reference to the drawings. In the drawings, like components are labeled with like reference numerals, and the detailed description thereof is omitted as appropriate.

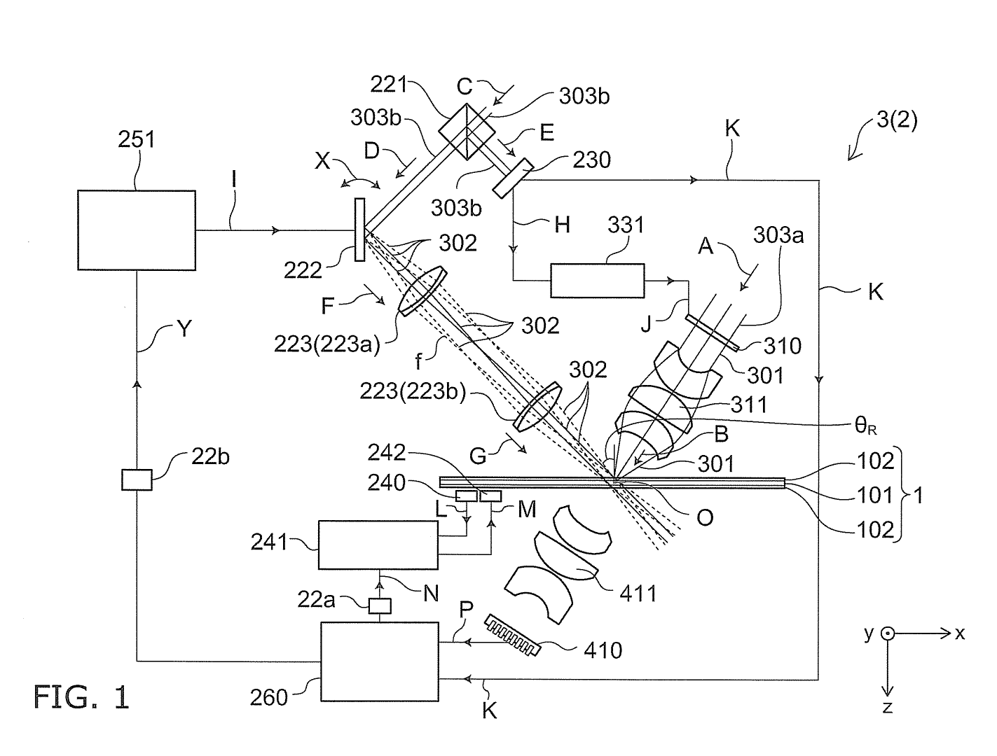

FIG. 1 is a schematic cross-sectional view illustrating the operation at the recording time of a hologram recording/reproducing apparatus (an optical information recording/reproducing apparatus) 2 capable of recording and reproduction according to an embodiment of the invention. That is, the hologram recording/reproducing apparatus 2 is an example of an optical information recording/repruducing apparatus. FIG. 1 illustrates the operation of a hologram recording apparatus 3 capable of recording included in the hologram recording/reproducing apparatus 2, and is an example of an optical information recording apparatus.

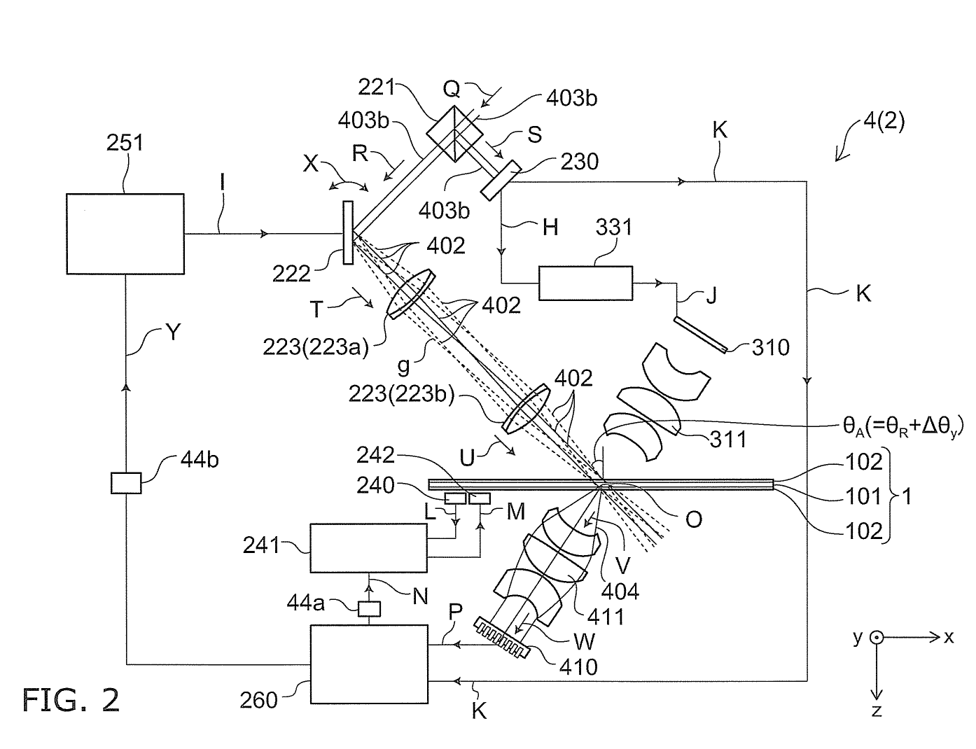

FIG. 2 is a schematic cross-sectional view illustrating the operation at the reproducing time of the hologram recording/reproducing apparatus 2 according to the embodiment of the invention. That is, FIG. 2 illustrates the operation of a hologram reproducing apparatus 4 capable of reproducing included in the hologram recording/reproducing apparatus 2, and is an example of an optical information reproducing apparatus according to the embodiment of the invention.

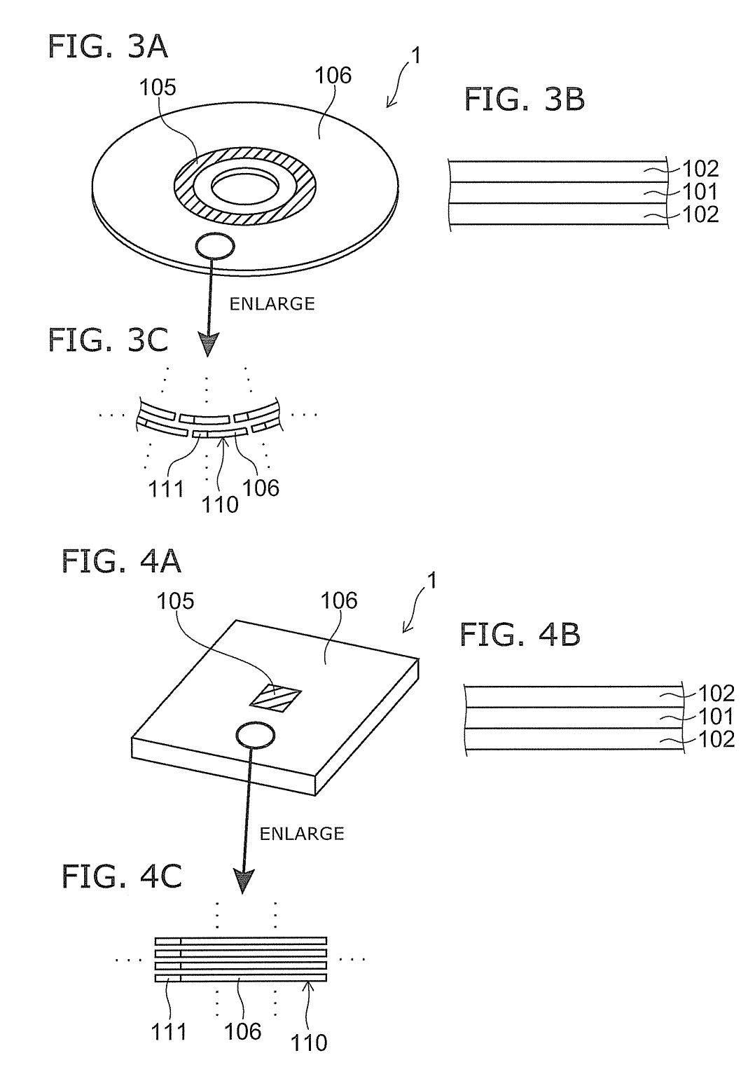

FIGS. 3A and 3C are schematic views illustrating a recording medium (an optical information recording medium) 1 according to the embodiment of the invention. The recording medium 1 is an example of an optical information recording medium according to the embodiment of the invention. FIGS. 4A and 4C are schematic views illustrating another recording medium 1 according to the embodiment of the invention. More specifically, FIGS. 3A and 4A are schematic perspective views of the recording medium 1, FIGS. 3B and 4B are schematic cross-sectional views of the recording medium 1 shown in FIGS. 3A and 4A, respectively, and FIGS. 3C and 4C are schematic plan views in which part of the recording medium 1 shown in FIGS. 3A and 4A is enlarged, respectively.

At the time of replaying a recording medium with hologram information (optical information) recorded thereon, an apparatus different from that used at the recording time may be used. In this case, the wavelength of the reference beam used at the recording time (hereinafter simply referred to as “reference beam”) may be different from the wavelength of the reference beam used at the reproducing time (hereinafter referred to as “reproduction illumination beam”). This wavelength difference may degrade the reproduced image. Thus, in this embodiment, the temperature of the recording medium and the incident angle of the reproduction illumination beam are adjusted illustratively using the wavelength of the reference beam and the wavelength of the reproduction illumination beam to appropriately reproduce the recorded information.

### Recording Medium

First, before the description of the hologram recording apparatus 3 and the hologram reproducing apparatus 4, the recording medium 1 is described with reference to FIGS. 3A to 4C.

As shown in FIGS. 3A to 4C, the recording medium 1 includes a recording layer 101 and substrates 102 sandwiching the recording layer 101. The recording layer 101 can be illustratively made of a photopolymer which changes its refractive index upon exposure to light. The photopolymer is a photosensitive material based on photopolymerization of polymerizable compounds (monomers), and can be a gel material containing a monomer, a photopolymerization initiator, and a matrix having a porous structure which serves to maintain the volume before and after recording. Currently, photopolymers are being developed toward higher sensitivity and increased multiplicity. The substrate 102 can be illustratively made of a polycarbonate, amorphous polyolefin, or glass. The substrate 102 serves to maintain the fixed shape of the recording layer 101 when the recording layer 101 is made of a gel material, and to protect the recording layer 101 from scratches and dust.

The shape of the recording medium 1 can illustratively be circular as shown in FIGS. 3A to 3C, or rectangular as shown in FIGS. 4A to 4C. A circular shape enables use of rotary driving for recording and reproduction and facilitates control. On the other hand, a rectangular shape has a larger area, and can record more information, than a circular shape whose diameter is equal to the length of its side.

As shown in FIGS. 3C and 4C, the recording medium 1 can include a lead-in region 105. The “lead-in region” refers to a region typically located in an inner region of the recording medium and storing identification information (such as recording format and specification) of the recording medium. In this case, a data region 106 for storing main data can be located outside the lead-in region 105. The main data (hereinafter also referred to as “main information”) includes a pattern corresponding to interference between an information beam 301 and a reference beam 302 (see FIG. 1). In the case where the data is recorded in several blocks, or tracks 110, it can include a header region 111. The “header region” is a region illustratively located in a leading portion of each track 110 and storing general information and the like of the track 110.

With the lead-in region 105 and the header region 111 thus provided, the hologram reproducing apparatus 4 can first obtain information necessary to replay the recording medium 1 from the lead-in region 105 and the header region 111, and then smoothly process the recording medium 1.

The layout of the lead-in region 105, the header region 111, the data region 106 and the like is not limited thereto, but any other layout can be used as long as each region can serve its function. In FIGS. 3A to 4C, the portions unnecessary for the description of this embodiment, such as the lead-out region, are not shown.

Here, on the recording medium 1, the information of the wavelength (hereinafter also referred to as “wavelength information”) of the reference beam 302 at the recording time is recorded. Thus, as described later, the hologram reproducing apparatus 4 can obtain the wavelength information from the recording medium 1 and use it to appropriately reproduce main information.

Furthermore, on the recording medium 1, the information of the temperature (hereinafter also referred to as “temperature information”) of the recording medium 1 at the recording time may be further recorded. Thus, as described later, the hologram reproducing apparatus 4 can obtain the temperature information from the recording medium 1 and use the wavelength information and the temperature information to appropriately reproduce main information. Writing of the temperature information can be performed when, for instance, the temperature at the recording time is not standardized in the hologram recording scheme and recording may be performed at various temperatures. Conversely, in such cases as the recording temperature is standardized, there is no need to write the temperature information.

The wavelength information and the temperature information can be recorded in the lead-in region 105 and/or the header region 111 of the recording medium 1.

The wavelength information and the temperature information can be designed so that they can be reproduced under a wider condition than the condition under which the main information can be reproduced. That is, the wavelength information and the temperature information may be written more robustly than the main information. For instance, several copies of the same information may be recorded by swinging the incident angle θ_{R} to increase the robustness. Alternatively, several copies of the same information may be recorded by swinging the temperature T1 to increase the robustness. Alternatively, recording can be performed in a smaller number of recorded pixels to effectively decrease the numerical aperture of the objective lens, thereby increasing the robustness. Thus, the hologram reproducing apparatus 4 can readily obtain these pieces of information.

### Hologram Recording/Reproducing Apparatus and Hologram Recording/Reproducing Method (Optical Information Recording/Reproducing Method)

Next, the hologram recording/reproducing apparatus and the hologram recording/reproducing method according to this embodiment are described with reference to FIGS. 1, 2, 5 to 10.

Schemes for recording/reproducing a hologram illustratively include the coaxial scheme (collinear scheme) in which the information beam and the reference beam are coaxially arranged, and the two-beam scheme (two-beam interference scheme) in which the information beam and the reference beam are arranged on different optical paths. In the following, an example of this embodiment based on the two-beam interference scheme is described. The two-beam interference scheme has such advantages as achieving higher recording density than the collinear scheme.

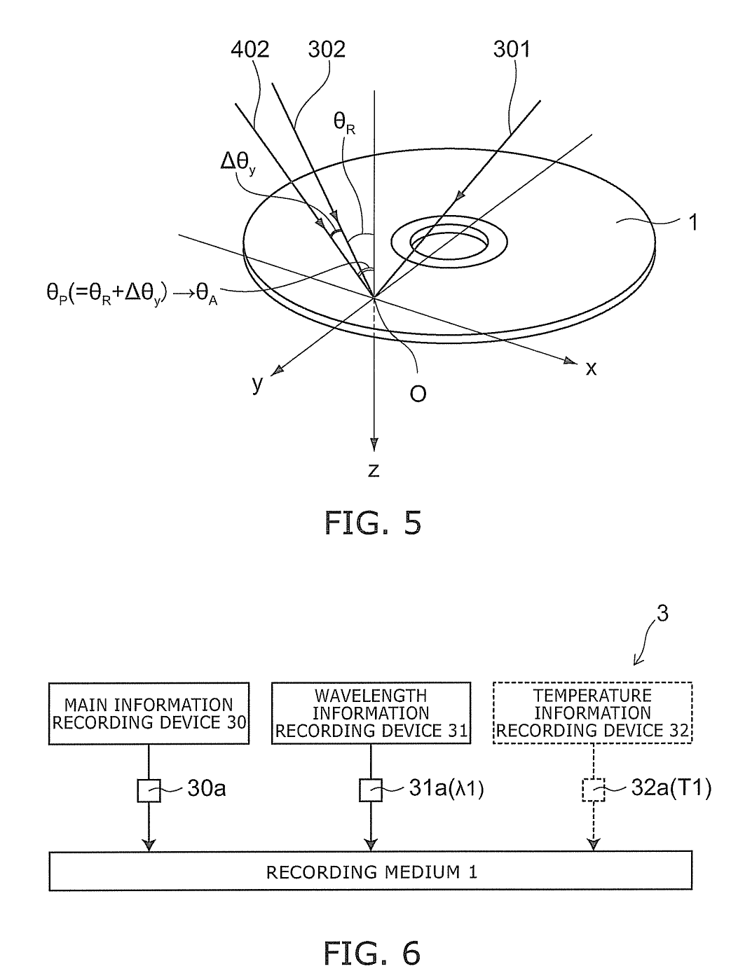

FIG. 5 is a schematic perspective view illustrating a coordinate system used to describe the hologram recording/reproducing method according to this embodiment.

As shown in FIG. 5, in this coordinate system, the x-axis and the y-axis are positioned on the plane of a disc-shaped recording medium 1, more particularly, on the plane located midway between the two surfaces of the recording layer 101. The x-axis and the y-axis are orthogonal to each other. Furthermore, the z-axis is positioned in the direction perpendicular to the x-axis and the y-axis. On the z-axis, with reference to the recording medium 1, the side on which the information beam, the reference beam and the like are incident is defined as the negative side, and the opposite side is defined as the positive side. The information beam, the reference beam and the like travel from the negative side to the positive side of the z-axis.

At the recording time, the intersection point O of these three axes and its neighborhood are irradiated with the information beam 301 and the reference beam 302 to record an interference pattern in the recording layer 101. It is assumed that the information beam 301 and the reference beam 302 both travel on the xz-plane. Here, the incident angle of the reference beam 302 with respect to the recording medium 1 in air is denoted by θ_{R}. With regard to angles such as the incident angle used herein, with reference to the z-axis negative side, the direction toward the x-axis negative side is defined as the positive direction, and the direction toward the x-axis positive side is defined as the negative direction. That is, as viewed from the y-axis positive side, with reference to the z-axis negative side, the counterclockwise direction is defined as the positive direction, and the clockwise direction is defined as the negative direction. For instance, the phrase “incident angle of 10 degrees” means 10 degrees from the negative side of the z-axis toward the x-axis negative side, and the phrase “incident angle of −10 degrees” means 10 degrees from the negative side of the z-axis toward the x-axis positive side. The “incident angle” used herein refers to the incident angle in air unless otherwise noted.

In this embodiment, it is possible to perform angle-multiple recording for recording interference patterns at the same location of the recording medium 1 with the incident angle θ_{R} of the reference beam 302 being varied, and shift-multiple recording for recording interference patterns with the recording locations being slightly shifted, and these can also be combined.

At the reproducing time, as described later, the recording medium 1 is irradiated with a reproduction illumination beam 402 which is controlled so that the incident angle θ_{P} of the reproduction illumination beam 402 with respect to the recording medium 1 is generally equal to the “aiming incident angle θ_{A}^{”}. The aiming incident angle θ_{A} is the value of the incident angle θ_{R} of the reference beam 302 with a prescribed compensation, i.e., θ_{A}=θ_{R}+Δθ_{y}. Because θ_{R} and θ_{A} can be regarded as rotation angles about the y-axis, “y” is used as a subscript of the compensation angle.

### Recording Time

In the following, the hologram recording apparatus and the hologram recording method according to this embodiment are described with reference to FIGS. 1, 6, and 7. The hologram recording method is an example of a optical information recording method.

FIG. 6 is a block diagram illustrating the control aspect of the hologram recording apparatus 3.

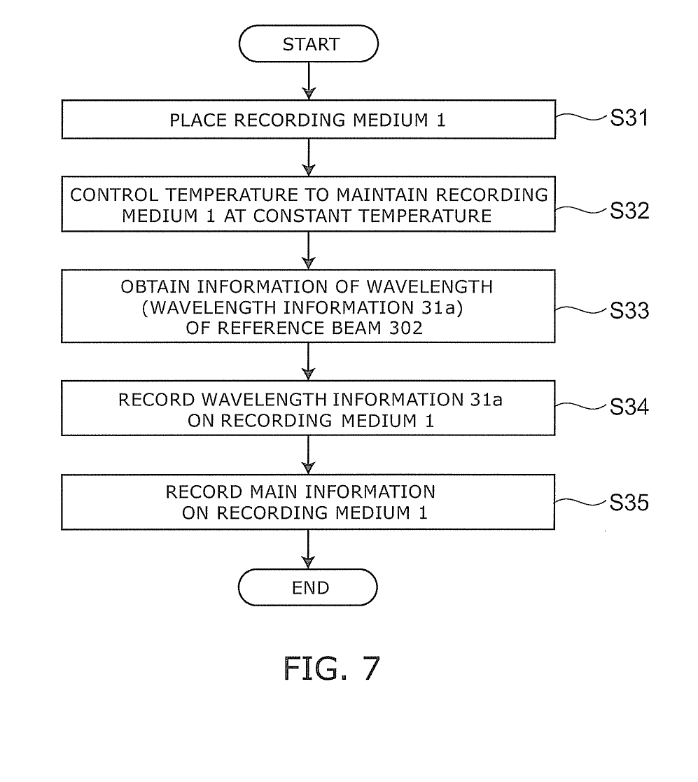

FIG. 7 is a flow chart illustrating the operation of the hologram recording apparatus 3.

As shown in FIG. 6, the hologram recording apparatus 3 includes a main information recording device 30 for recording main information 30a on the recording medium 1 by injecting an information beam 301 and a reference beam 302 into the recording medium 1 to form a pattern corresponding to interference between the information beam 301 and the reference beam 302. The main information recording device 30 illustratively includes components for applying the information beam 301, such as a spacial light modulator 310 and an objective lens 311, and components for applying the reference beam 302, such as a galvanomirror 222 and relay lenses 223, as described in FIG. 1.

Furthermore, as shown in FIG. 6, the hologram recording apparatus 3 includes a wavelength information recording device 31 for recording the information of the wavelength (wavelength information 31a) of the reference beam 302 on the recording medium 1. In the case where the wavelength information 31a is recorded as hologram information, the wavelength information recording device 31 illustratively includes the components for applying the information beam 301 and the components for applying the reference beam 302 described above. That is, the main information recording device 30 and the wavelength information recording device 31 do not need to be completely independent elements, but may share part of their components with each other. Furthermore, as shown in FIG. 1, the hologram recording apparatus 3 may further include a wavelength sensing device 230 for sensing the wavelength λ1 of the reference beam 302.

Furthermore, as shown in FIG. 6, the hologram recording apparatus 3 may further include a temperature information recording device 32 for recording the information of the temperature (temperature information 32a) of the recording medium 1 at the recording time on the recording medium 1. In the case where the temperature information 32a is recorded as hologram information, the temperature information recording device 32 illustratively includes the components for applying the information beam 301 and the components for applying the reference beam 302 described above. That is, the main information recording device 30 and the temperature information recording device 32 do not need to be completely independent elements, but may share part of their components with each other. Furthermore, as shown in FIG. 1, the hologram recording apparatus 3 may further include a temperature sensor (temperature sensing device) 240 for sensing the temperature T1 of the recording medium 1.

With the wavelength information 31a and, if necessary, the temperature information 32a thus recorded on the recording medium 1, the hologram reproducing apparatus 4 can obtain these pieces of information from the recording medium 1 to appropriately replay the recording medium 1.

Next, the recording operation is described in detail.

First, as shown in FIG. 1 and step S31 of FIG. 7, a recording medium 1 is placed at a prescribed location in the hologram recording apparatus 3.

Subsequently, as shown in step S32 of FIG. 7, temperature control can be performed so that the recording medium 1 is maintained at a constant temperature, such as a standard temperature (e.g., 25° C.). Keeping constant the temperature of the recording medium 1 facilitates temperature control of the recording medium 1 at the reproducing time.

The temperature control of the recording medium 1 can be performed illustratively by using the temperature sensor 240 and a temperature control device configured to control the temperature of the recording medium 1 and including a temperature control circuit 241 and a temperature adjustment device 242, as shown in FIG. 1.

The temperature sensor 240 can illustratively be a noncontact temperature measuring device such as an infrared radiation thermometer. The infrared radiation thermometer is a device for sensing infrared radiation from an object to measure the temperature of the object, and may have a pointer function for determining the measurement location using a laser or the like. In the case of shift-multiple recording, recording/reproduction is performed with the recording medium 1 being in motion, such as rotation, and thus a noncontact temperature measuring device is suitably used. The temperature adjustment device 242 adjusts the temperature of the recording medium 1, and can illustratively be a heating/cooling device including a heater and a Peltier element.

As shown in FIG. 1, the temperature sensor 240 measures the temperature of the recording medium 1, and transmits temperature information 32a to the temperature control circuit 241 as shown by arrow L. Then, as shown by arrow M, the temperature control circuit 241 controls the temperature adjustment device 242 on the basis of the actual temperature and target temperature of the recording medium 1. Thus, feedback control can be performed so as to keep constant the temperature of the recording medium 1. In this case, as a possible configuration, a controller 260 can be used to control the temperature of the recording medium 1. More specifically, as shown by arrow N, the controller 260 transmits to the temperature control circuit 241 instruction information 22a dictating that the temperature of the recording medium 1 be controlled to be generally equal to a prescribed temperature. Then, on the basis of the instruction information 22a, the temperature control circuit 241 performs feedback control on the temperature of the recording medium 1 using the temperature sensor 240 and the temperature adjustment device 242 as shown by arrows L and M. Thus, the temperature of the recording medium 1 can be arbitrarily adjusted.

Subsequently, as shown in step S33 of FIG. 7, the hologram recording apparatus 3 obtains the information of the wavelength (wavelength information 31a) of the reference beam 302. The wavelength λ1 of the reference beam 302 can be sensed in the following manner using the wavelength sensing device 230 shown in FIG. 1. The wavelength sensing device 230 can illustratively be a conventional wavemeter.

As shown by arrow C of FIG. 1, a coherent beam 303b such as from a laser is split by a beam splitter (light beam splitting device) 221. One of the split beams can be used to generate a reference beam 302 as shown by arrow D, and the other split beam can be injected into the wavelength sensing device 230 as shown by arrow E and can be used to obtain the wavelength λ1 of the reference beam 302. Because the wavelength of the beam 303b is equal to that of the reference beam 302, the wavelength λ1 of the reference beam 302 can be obtained by obtaining the wavelength of the beam 303b.

Here, if the wavelength of the beam 303b does not vary and can be obtained by another technique, there is no need to provide the wavelength sensing device 230. Accordingly, there is also no need to provide the beam splitter 221, and the beam 303b can be entirely used to generate a reference beam 302.

Subsequently, as shown in step S34 of FIG. 7, the hologram recording apparatus 3 records the wavelength information 31a on the recording medium 1. The wavelength information 31a can be recorded as hologram information, or may be recorded in other formats. In the case where it is recorded as hologram information, it can be recorded in the following manner.

As shown by arrow A of FIG. 1, a coherent beam 303a such as from a laser is injected into the spacial light modulator 310. The spacial light modulator 310 can be a spacial light modulator based on liquid crystal or a digital micromirror, such as the ferroelectric liquid crystal on silicon (FLCOS) device manufactured by Micron Displaytech Inc., U.S., and the digital micromirror device (DMD) manufactured by Texas Instruments Inc., U.S., for instance.

Furthermore, as shown by arrow H, the wavelength information 31a obtained by the wavelength sensing device 230 is transmitted to an encoder 331. The encoder 331 encodes the wavelength information 31a into binary data and inputs this binary data to the spacial light modulator 310 as shown by arrow 3.

Then, on the basis of this input signal, the spacial light modulator 310 spatially modulates the beam 303a. For instance, it is intensity-modulated in a binary pattern of bright and dark spots. Thus, an information beam 301 carrying the wavelength information 31a to be recorded on the recording medium 1 can be generated.

In the case where the temperature information 32a is recorded on the recording medium 1, the temperature information 32a obtained by the temperature sensor 240 can be carried on the information beam 301 in a similar manner. Here, in such cases as the temperature at the recording time is defined in the standards and the like, there is no need to record the temperature information 32a on the recording medium 1.

Subsequently, by using the objective lens 311, as shown by arrow B, the information beam 301 is converged and applied to a prescribed location on the recording medium 1, such as the lead-in region 105 or the header region 111. In the case where the wavelength λ1 of the reference beam 302 and the temperature T1 of the recording medium 1 change during the recording operation, the wavelength information 31a and the temperature information 32a can be recorded in the header region 111.

As an example of the objective lens, an objective lens with a three-group, three-element design is shown in FIG. 1. In the case where a hologram recording/reproducing apparatus 2 is constructed by combining a hologram recording apparatus 3 and a hologram reproducing apparatus 4, it is possible to use a so-called tandem arrangement in which two objective lenses 311, 411 are opposed across the recording medium 1 as shown. Here, if an objective lens with high numerical aperture is used, it needs to be a multi-group lens for the purpose of reducing the field curvature and ensuring the working distance. Although FIG. 1 shows a three-group, three-element design, naturally, other designs can be used if imaging performance is ensured.

On the other hand, the beam 303b shown by arrow D of FIG. 1 is reflected by the galvanomirror 222 to generate a reference beam 302. Then, as shown by arrows F and G, the reference beam 302 is applied to the prescribed location on the recording medium 1, that is, the same location as the location irradiated with the information beam 301.

As shown by arrows I and X, the reference beam 302 can be applied to the recording medium 1 with the incident angle being varied by rotationally driving the galvanomirror 222 using an incident angle control circuit 251. Thus, angle-multiple recording can be performed on the same location of the recording medium 1. In this case, as a possible configuration, the controller 260 can be used to control the operation of the galvanomirror 222. More specifically, as shown by arrow Y, the controller 260 transmits to the incident angle control circuit 251 instruction information 22b dictating that the incident angle θ_{R} of the reference beam 302 be controlled to be generally equal to a prescribed angle. Then, on the basis of the instruction information 22b, the incident angle control circuit 251 drives the galvanomirror 222 as shown by arrows I and X to control the incident angle θ_{R} of the reference beam 302 to be generally equal to the prescribed angle. Thus, the incident angle θ_{R} of the reference beam 302 can be arbitrarily adjusted.

As a possible configuration, the reference beam 302 can be injected into the recording medium 1 through relay lenses 223 as shown in FIG. 1. The galvanomirror 222, the relay lenses 223, and the recording medium 1 can be arranged in consideration of the focal length f of the relay lenses 223. For instance, it is possible to use a 4f-optical arrangement in which the distance between the galvanomirror 222 and the first relay lens 223a is equal to f, the distance between the first relay lens 223a and the second relay lens 223b is equal to 2f, and the distance between the second relay lens 223b and the recording medium 1 is equal to f. This enables the reference beam 302 to be applied to the same location of the recording medium 1 as shown by dashed line f even if the incident angle θ_{R} of the reference beam 302 is varied by rotationally driving the galvanomirror 222.

Thus, the information beam 301 and the reference beam 302 can be injected into the recording medium 1 (more particularly, the recording layer 101) to record a pattern corresponding to interference between the information beam 301 and the reference beam 302 on the recording medium 1. This enables the wavelength information 31a and, if necessary, the temperature information 32a contained in the information beam 301 to be recorded as an interference pattern on the recording medium 1.

The wavelength information 31a and the temperature information 32a may be recorded so that they can be reproduced under a wider condition than the condition under which the main information 30a can be reproduced. For instance, several copies of the same information may be recorded by swinging the incident angle θ_{R} to increase the robustness. Alternatively, several copies of the same information may be recorded by swinging the temperature T1 to increase the robustness. Alternatively, recording can be performed in a smaller number of recorded pixels to effectively decrease the numerical aperture of the objective lens, thereby increasing the robustness.

Next, as shown in step S35 of FIG. 7, the hologram recording apparatus 3 records the main information 30a on the recording medium 1.

The main information 30a can be recorded on the recording medium 1 in a similar method to the method for recording the wavelength information 31a described above with reference to step S34.

First, as shown by arrow A of FIG. 1, a coherent beam 303a from a laser is injected into the spacial light modulator 310. The spacial light modulator 310 spatially modulates the beam 303a on the basis of the main information 30a to be recorded on the recording medium 1. For instance, it is intensity-modulated in a binary pattern of bright and dark spots. More specifically, the information to be recorded is digitally coded into a binary pattern with an error-correcting code embedded therein. Thus, an information beam 301 carrying the main information 30a can be generated.

Subsequently, by using the objective lens 311, as shown by arrow B, the information beam 301 is converged and applied to a prescribed location on the recording medium 1, such as the data region 106.

On the other hand, the beam 303b shown by arrow D of FIG. 1 is reflected by the galvanomirror 222 to generate a reference beam 302. Then, as shown by arrows F and G, the reference beam 302 is applied to the prescribed location on the recording medium 1, that is, the same location as the location irradiated with the information beam 301. Here, in the manner described above with reference to step S34, angle-multiple recording can be performed by rotationally driving the galvanomirror 222. Furthermore, as described above with reference to step S34, as a possible configuration, the reference beam 302 can be injected into the recording medium 1 through relay lenses 223.

Thus, the information beam 301 and the reference beam 302 can be injected into the recording medium 1 (more particularly, the recording layer 101) to record a pattern corresponding to interference between the information beam 301 and the reference beam 302 on the recording medium 1. This enables the main information 30a contained in the information beam 301 to be recorded as an interference pattern on the recording medium 1.

In the case where the information recorded on the recording medium 1 is divided into a plurality of tracks 110 and the wavelength information 31a and the temperature information 32a are recorded in the header region 111, steps S32 to S35 or steps S33 to S35 can be repeated.

The hologram recording apparatus 3 may record other conditions at the recording time on the recording medium 1. For instance, the conditions include the incident angle of the information beam 301 and the reference beam 302, the linear expansion coefficient of the recording layer 101, and the refractive index of the recording layer 101. As described later, these recording conditions also serve as parameters used in determining the temperature at the reproducing time and the incident angle of the reproduction illumination beam 402. Hence, these recording conditions may be recorded on the recording medium 1 if, for instance, they are not standardized and varied.

### Reproducing Time

Next, the hologram reproducing apparatus and the hologram reproducing method according to this embodiment are described with reference to FIGS. 2, 8 to 10. The hologram reproducing method is an example of an optical information reproducing method according to this embodiment of the invention.

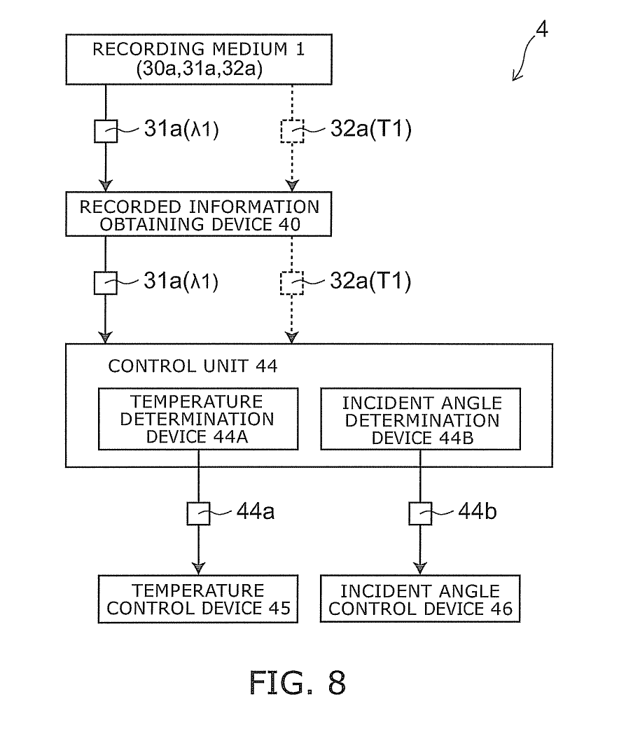

FIG. 8 is a block diagram illustrating the control aspect of the hologram reproducing apparatus 4.

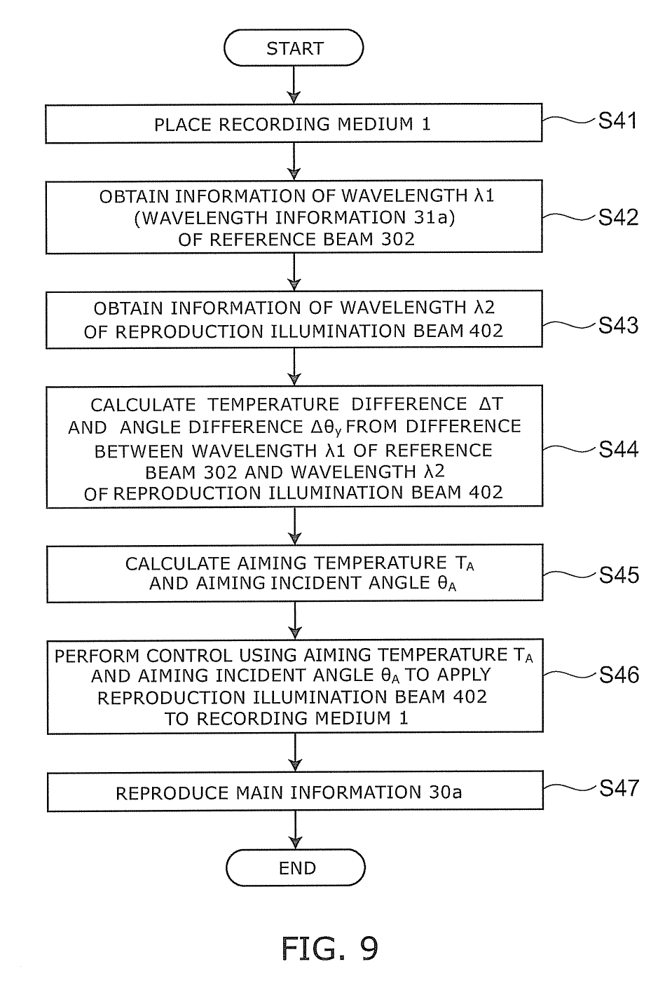

FIG. 9 is a flow chart illustrating the operation of the hologram reproducing apparatus 4.

In general, the hologram recording apparatus 3 used to record the recording medium 1 and the hologram reproducing apparatus 4 used to replay the recording medium 1 are not identical in optical environment, and the wavelength λ1 of the reference beam 302 at the recording time and the wavelength λ2 of the reproduction illumination beam 402 at the reproducing time are generally different. This also holds true even if the hologram recording apparatus 3 and the hologram reproducing apparatus 4 are a hologram recording/reproducing apparatus 2 having the same specification. If the wavelength thus varies between the recording time and the reproducing time, the Bragg condition satisfied at the recording time may fail to be satisfied at the reproducing time, degrading the reproduced image.

Thus, in this embodiment, the reproduced image is compensated by using two parameters, the temperature of the recording medium 1 and the incident angle of the reproduction illumination beam 402.

As shown in FIG. 8, the hologram reproducing apparatus 4 includes a recorded information obtaining device 40 for obtaining wavelength information 31a from the recording medium 1 which stores main information 30a recorded as a pattern corresponding to interference between the information beam 301 and the reference beam 302 illustratively by the main information recording device 30, and the information of the wavelength (wavelength information 31a) of the reference beam 302 at the recording time recorded illustratively by the wavelength information recording device 31. The recorded information obtaining device 40 illustratively includes components for reproducing recorded information, such as an objective lens 411 and an imaging device 410 shown in FIG. 2.

Furthermore, the hologram reproducing apparatus 4 includes a main information reproducing device (not shown in FIG. 8) for obtaining the main information 30a recorded on the recording medium 1 by applying a reproduction illumination beam. The main information reproducing device illustratively includes components for reproducing recorded information, such as an objective lens 411 and an imaging device 410 shown in FIG. 2.

Furthermore, as shown in FIG. 8, the hologram reproducing apparatus 4 includes a control unit 44 for controlling the temperature of the recording medium 1 and the incident angle of an illumination beam for use in reproduction (reproduction illumination beam 402) by using the wavelength information 31a obtained from the recorded information obtaining device 40. The control unit 44 includes a temperature determination device 44A and an incident angle determination device 44B. The temperature determination device 44A determines an “aiming temperature T_{A}”, which is the temperature of the recording medium 1 suited to reproduce the interference pattern on the basis of the difference between the wavelength λ1 of the reference beam 302 and the wavelength λ2 of the reproduction illumination beam 402. Furthermore, the incident angle determination device 44B determines an “aiming incident angle θ_{A}”, which is the incident angle of the reproduction illumination beam 402 suited to reproduce the interference pattern on the basis of the difference between the wavelength λ1 of the reference beam 302 and the wavelength λ2 of the reproduction illumination beam 402. Here, it is possible to use a configuration in which the temperature determination device 44A and the incident angle determination device 44B are integrated together.

As shown in FIG. 2, the hologram reproducing apparatus 4 may further include a wavelength sensing device 230 for sensing the wavelength λ2 of the reproduction illumination beam 402.

The control unit 44 can illustratively be the controller 260 shown in FIG. 2. The controller 260 is described later in detail.

Furthermore, as shown in FIG. 8, the hologram reproducing apparatus 4 includes a temperature control device for obtaining instruction information 44a about the temperature from the control unit 44 and controlling the temperature of the recording medium 1. The temperature control device 45 illustratively includes a temperature control circuit 241 and a temperature adjustment device 242 shown in FIG. 2. The temperature control device 45 controls the temperature of the recording medium 1 so that the temperature of the recording medium 1 is generally equal to the aiming temperature T_{A}. The hologram reproducing apparatus 4 may further include a temperature sensor 240 for sensing the temperature of the recording medium 1.

Furthermore, as shown in FIG. 8, the hologram reproducing apparatus 4 includes an incident angle control device 46 for obtaining instruction information 44b about the incident angle from the control unit 44 and controlling the incident angle of the reproduction illumination beam 402. The incident angle control device 46 illustratively includes an incident angle control circuit 251 and a galvanomirror 222 shown in FIG. 2. The incident angle control device 46 controls the incident angle of the reproduction illumination beam 402 so that the incident angle of the reproduction illumination beam 402 is generally equal to the aiming incident angle θ_{A}.

Furthermore, as shown in FIG. 8, the recorded information obtaining device 40 may obtain temperature information 32a from the recording medium 1 on which the information of the temperature T1 (temperature information 32a) of the recording medium 1 at the recording time is further recorded. In this case, the temperature determination device 44A can determine the aiming temperature T_{A} by further using the recording temperature T1.

The hologram reproducing apparatus 4 generates a reproduced beam 404 diffracted from the interference pattern by applying the reproduction illumination beam 402 to the recording medium 1 while performing the aforementioned control on the temperature of the recording medium 1 and the incident angle of the reproduction illumination beam 402. The main information 30a is obtained by processing this reproduced beam 404.

Thus, the hologram reproducing apparatus 4 can obtain the wavelength information 31a and, if necessary, the temperature information 32a from the recording medium 1, and use these pieces of information to appropriately replay the recording medium 1.

Next, the reproducing operation is described in detail.

First, as shown in FIG. 2 and step S41 of FIG. 9, a recording medium 1 with main information 30a and wavelength information 31a recorded thereon as an interference pattern is placed at a prescribed location in the hologram reproducing apparatus 4. At the recording time and the reproducing time, recording of the recording medium 1 and replay of the recording medium 1 may be performed using the same apparatus (an apparatus having both the recording function and the reproducing function), or may be performed using different apparatuses.

Subsequently, as shown in step S42 of FIG. 9, the hologram reproducing apparatus 4 obtains the information of the wavelength λ1 (wavelength information 31a) of the reference beam 302 from the lead-in region 105, the header region 111 or the like of the recording medium 1. In the case where the wavelength information 31a is recorded as hologram information, the wavelength information 31a can be obtained by the following method.

First, as shown by arrow Q of FIG. 2, a coherent beam 403b from a laser is split by a beam splitter 221. One of the split beams can be used to generate a reproduction illumination beam 402 as shown by arrow R, and the other split beam can be injected into the wavelength sensing device 230 as shown by arrow S and can be used to obtain the wavelength λ2 of the reproduction illumination beam 402.

Subsequently, by a similar method to the method for generating and applying a reference beam 302 described above with reference to FIG. 1, the reproduction illumination beam 402 is generated and applied to the recording medium 1.

More specifically, the beam 403b shown by arrow R of FIG. 2 is reflected by the galvanomirror 222 to generate a reproduction illumination beam 402. Then, as shown by arrows T and U, the reproduction illumination beam 402 is applied to a prescribed location on the recording medium 1, such as the lead-in region 105, the header region 111 or the like to generate a reproduced beam 404 diffracted from the interference pattern recorded in that region.

As shown by arrows I and X, the reproduction illumination beam 402 can be applied to the recording medium 1 with the incident angle being varied by rotationally driving the galvanomirror 222 using the incident angle control circuit 251. This enables the wavelength information 31a to be reliably obtained. Here, as described above with reference to FIG. 1, as a possible configuration, instruction information 22b can be transmitted from the controller 260 to the incident angle control circuit 251, and on the basis of the instruction information 22b, the incident angle control circuit 251 can control the driving of the galvanomirror 222. Furthermore, as a possible configuration, the reproduction illumination beam 402 can be injected into the recording medium 1 through relay lenses 223.

Furthermore, in obtaining the wavelength information 31a, the temperature of the recording medium 1 may be adjusted to a prescribed temperature, such as a standard temperature (e.g., 25° C.) which facilitates obtaining the wavelength information 31a. This temperature adjustment can be performed using the controller 260, the temperature control circuit 241, the temperature sensor 240, and the temperature adjustment device 242 as described above with reference to FIG. 1.

Subsequently, as shown by arrows V and W of FIG. 2, the reproduced beam 404 is generally collimated by the objective lens 411. Then, the imaging device 410 of CMOS (complementary metal oxide semiconductor) or CCD (charge coupled device) receives the reproduced beam 404 as a two-dimensional image. Subsequently, this two-dimensional image is decoded by a decoder (not shown) to obtain the wavelength information 31a. Thus, the wavelength λ1 of the reference beam 302 used at the recording time is obtained.

If the temperature information 32a and other recording conditions (such as the incident angle of the information beam 301 and the reference beam 302, the linear expansion coefficient of the recording layer 101, and the refractive index of the recording layer 101) are recorded as hologram information on the recording medium 1, these pieces of information can be obtained in a similar manner. Here, in such cases as the temperature at the recording time, for instance, is defined in the standards, there is no need to obtain the temperature information 32a and the like.

Subsequently, as shown by arrow P of FIG. 2, the wavelength information 31a and, if necessary, the temperature information 32a and the like are transmitted to the controller 260.

Subsequently, as shown in step S43 of FIG. 9, the hologram reproducing apparatus 4 obtains the information of the wavelength λ2 of the reproduction illumination beam 402. For instance, as shown by arrow S of FIG. 2, one of the beams 403b split by the beam splitter 221 can be injected into the wavelength sensing device 230 to obtain the wavelength λ2 of the reproduction illumination beam 402. Because the wavelength of the beam 403b is equal to that of the reproduction illumination beam 402, the wavelength λ2 of the reproduction illumination beam 402 can be obtained by obtaining the wavelength of the beam 403b in the wavelength sensing device 230.

Here, if the wavelength of the beam 403b does not vary and can be obtained by another technique, there is no need to provide the wavelength sensing device 230. Accordingly, there is also no need to provide the beam splitter 221, and the beam 403b can be entirely used to generate a reproduction illumination beam 402.

Subsequently, as shown by arrow K of FIG. 2, the information of the wavelength λ2 of the reproduction illumination beam 402 is transmitted to the controller 260.

Thus, the controller 260 obtains the information of the wavelength λ1 of the reference beam 302 and the information of the wavelength λ2 of the reproduction illumination beam 402.

Subsequently, as shown in step S44 of FIG. 9, on the basis of the difference Δλ between the wavelength λ1 of the reference beam 302 and the wavelength λ2 of the reproduction illumination beam 402, the hologram reproducing apparatus 4 determines the difference (temperature difference ΔT) between the aiming temperature T_{A} and the temperature of the recording medium 1 at the recording time and the difference (angle difference Δθ_{y}) between the aiming incident angle θ_{A} and the incident angle θ_{R} of the reference beam 302 at the recording time.

The determination of the temperature difference ΔT and the angle difference Δθ_{y}, and the aiming temperature T_{A} and the aiming incident angle θ_{A} described later, can be performed using the controller 260 shown in FIG. 2. Here, the controller 260 may store a computer program, and the determination operation may be performed using this computer program. The controller 260 can be configured to include a computing section illustratively composed of a CPU (central processing unit), a main memory device illustratively composed of ROM (read-only memory) and RAM (random access memory), an auxiliary storage device illustratively composed of a hard disc, and input/output interfaces, which are interconnected illustratively by a bus. The CPU performs information processing in accordance with a program stored in the ROM or a program loaded from the auxiliary storage device into the RAM.

In the following, the method for determining the temperature difference ΔT and the angle difference Δθ_{y} is described.

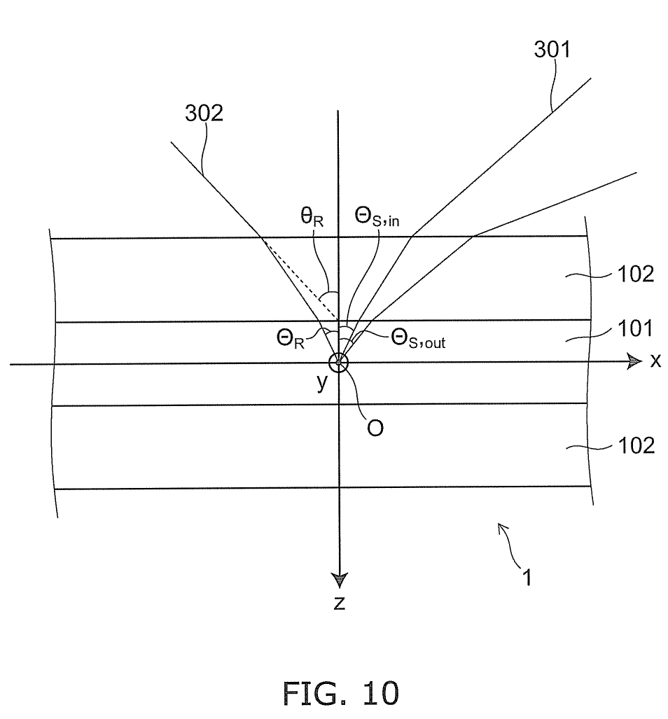

FIG. 10 is a schematic cross-sectional view for describing parameters used in the method for determining the temperature difference ΔT and the angle difference Δθ_{y}.

First, the temperature difference ΔT is calculated using the following equation (1).

$$Δ T = \frac{Δ λ}{{λ}_{1} \cdot [ \frac{{γ}_{x} + {γ}_{z}}{2} - U ( {γ}_{z} - {γ}_{x} ) ]} \qquad ( 1 )$$

In equation (1), γₓ is the linear expansion coefficient of the recording layer 101 in the xy-plane, and γ_{z} is the linear expansion coefficient of the recording layer 101 in the z-direction. These physical property values of the recording layer 101 can be stored beforehand in a memory included in the controller 260 or the like.

Furthermore, “U” in equation (1) is given by the following equation (2).

$$U = cos ( {Θ}_{R} + \frac{{Θ}_{S , i n} + {Θ}_{S , out}}{2} ) cos ( \frac{{Θ}_{S , i n} - {Θ}_{S , out}}{2} ) + \frac{cos ( {Θ}_{S , i n} + {Θ}_{S , out} )}{2} \qquad ( 2 )$$

In equation (2), Θ_{R} is the incident angle of the reference beam 302 in the recording layer 101 as shown in FIG. 10. Furthermore, Θ_{S,in} is the incident angle of the innermost ray of the information beam 301 in the recording layer 101, and Θ_{S,out} is the incident angle of the outermost ray of the information beam 301 in the recording layer 101. Because the information beam 301 is converged by the objective lens 311, the incident angle is thus varied with the location of the ray.

Furthermore, the angle difference Δθ_{y} is calculated using the following equation (3).

$$Δ {θ}_{y} = - \frac{nV ( {γ}_{z} - {γ}_{x} ) cos {Θ}_{R }}{cos {θ}_{R}} \cdot Δ T \qquad ( 3 )$$

In equation (3), θ_{R} is the incident angle of the reference beam 302 in air as shown in FIG. 10, and n is the refractive index of the recording layer 101. Like the linear expansion coefficients γₓ and γ_{z}, the refractive index n can also be stored beforehand in a memory included in the controller 260 or the like.

Furthermore, “V” in equation (3) is given by the following equation (4).

$$V = sin ( {Θ}_{R} + \frac{{Θ}_{S , i n} + {Θ}_{S , out}}{2} ) cos ( \frac{{Θ}_{S , i n} - {Θ}_{S , out}}{2} ) - \frac{1}{2} sin ( {Θ}_{S , i n} + {Θ}_{S , out} ) \qquad ( 4 )$$

Here, equations (1) and (3) can be rewritten into the following equations (5) and (6), respectively, using constants α and β which are determined by the physical property values of the recording layer 101 and the optical arrangement such as the numerical aperture and incident angle of the objective lens 311.

ΔT=α·Δλ (5)

Δθ_{y}=β·ΔT=αβ·Δλ (6)

That is, the temperature difference ΔT and the angle difference Δθ_{y}, which are the control parameters used to compensate the reproduced image, can both be described as linear expressions in the wavelength difference Δλ. Thus, the effect of this embodiment can be achieved by simple control.

Subsequently, as shown in step S45 of FIG. 9, the hologram reproducing apparatus 4 determines the aiming temperature T_{A}, that is, “temperature T1 of the recording medium 1 at the recording time+temperature difference ΔT”, and the aiming incident angle θ_{A}, that is, “incident angle θ_{R} of the reference beam 302+angle difference Δθ_{y}”.

With regard to the temperature T1 of the recording medium 1 at the recording time and the incident angle θ_{R} of the reference beam 302, if they are defined in the standards and the like, the numerical values thereof can be used. Alternatively, if they are recorded on the recording medium 1, they can be obtained from the recording medium 1.

The hologram reproducing apparatus 4 may determine, if necessary, the aiming temperature T_{A} and the aiming incident angle θ_{A} through feedback on the aiming temperature T_{A} and the aiming incident angle θ_{A} once determined. More specifically, the hologram reproducing apparatus 4 reproduces the image using the aiming temperature T_{A} and the aiming incident angle θ_{A} once determined, and verifies whether the image is appropriately reproduced. Then, if necessary, the aiming temperature T_{A} and the aiming incident angle θ_{A} once determined are corrected. By refining the aiming temperature T_{A} and the aiming incident angle θ_{A} through such feedback control, the image can be reproduced more favorably. Here, in determining the aiming temperature T_{A}, the information about the temperature detected by the temperature sensor 240 may be used.

Subsequently, as shown in step S46 of FIG. 9, the hologram reproducing apparatus 4 applies the reproduction illumination beam 402 to the recording medium 1 while performing control on the temperature and incident angle using the aiming temperature T_{A} and the aiming incident angle θ_{A} in the following manner.

As shown by arrow N of FIG. 2, the controller 260 transmits to the temperature control circuit 241 instruction information 44a dictating that the temperature of the recording medium 1 be controlled to be generally equal to the aiming temperature T_{A}. On the basis of the instruction information 44a, the temperature control circuit 241 performs control using the temperature sensor 240 and the temperature adjustment device 242 as shown by arrows L and M so that the temperature of the recording medium 1 is generally equal to the aiming temperature T_{A}.

Furthermore, as shown by arrow Y of FIG. 2, the controller 260 transmits to the incident angle control circuit 251 instruction information 44b dictating that the incident angle of the reproduction illumination beam 402 be controlled to be generally equal to the aiming incident angle θ_{A}. On the basis of the instruction information 44b, the incident angle control circuit 251 drives the galvanomirror 222 as shown by arrows I and X to perform control so that the incident angle of the reproduction illumination beam 402 is generally equal to the aiming incident angle θ_{A}.

Control of the temperature of the recording medium 1 and control of the incident angle of the reproduction illumination beam 402 may be performed simultaneously, or at different times. In the latter case, the order of these controls does not matter. That is, temperature control of the recording medium 1 may precede, or conversely, incident angle control of the reproduction illumination beam 402 may precede.

While performing such control, as shown by arrows T and U of FIG. 2, the reproduction illumination beam 402 is applied to a prescribed location on the recording medium 1, such as the data region 106, to generate a reproduced beam 404 diffracted therefrom.

Subsequently, as shown in step S47 of FIG. 9, an image, that is, main information 30a recorded as an interference pattern, is reproduced. This reproduction can be performed in a similar method to the method described above with reference to step S42 of FIG. 9.

More specifically, as shown by arrows V and W of FIG. 2, the reproduced beam 404 is generally collimated by the objective lens 411. Then, the imaging device 410 receives the reproduced beam 404 as a two-dimensional image. Subsequently, this two-dimensional image is decoded by a decoder (not shown) to obtain the main information 30a.

Thus, the main information 30a can be reproduced.

### Hologram Recording/Reproducing Apparatus

The hologram recording apparatus 3 and the hologram reproducing apparatus 4 according to this embodiment can be combined as shown in FIGS. 1 and 2. More specifically, the hologram recording/reproducing apparatus 2 according to this embodiment includes a main information recording device 30 for injecting a first information beam 301 and a first reference beam 302 into a first recording medium 1 to record first main information 30a on the first recording medium 1 as a first pattern corresponding to interference between the first information beam 301 and the first reference beam 302; and a wavelength information recording device 31 for recording information about the wavelength of the first reference beam 302 on the first recording medium 1.

Furthermore, the hologram recording/reproducing apparatus 2 includes a device for obtaining information about the wavelength of a second reference beam 302 from a second recording medium 1 which stores second main information 30a recorded as a second pattern corresponding to interference between a second information beam 301 and the second reference beam 302 illustratively by the main information recording device 30, and information about the wavelength of the second reference beam 302 at the recording time recorded illustratively by the wavelength information recording device 31; a main information reproducing device for obtaining the main information 30a recorded on the second recording medium by applying a reproduction illumination beam 402; a temperature determination device 44A for determining the temperature (aiming temperature T_{A}) of the second recording medium 1 suited to reproduce the second pattern on the basis of the difference between the wavelength of the second reference beam 302 and the wavelength of the reproduction illumination beam 402; an incident angle determination device 44B for determining the incident angle (aiming incident angle θA) of the reproduction illumination beam 402 suited to reproduce the second pattern using the difference between the wavelength of the second reference beam 302 and the wavelength of the reproduction illumination beam 402; a temperature control device 45 for controlling the temperature of the second recording medium 1; and an incident angle control device 46 for controlling the incident angle of the reproduction illumination beam 402. The temperature control device 45 controls the temperature of the second recording medium 1 so that the temperature of the second recording medium 1 is generally equal to the aiming temperature T_{A}, and the incident angle control device 46 controls the incident angle of the reproduction illumination beam 402 so that the incident angle of the reproduction illumination beam 402 is generally equal to the aiming incident angle θ_{A}.

In the foregoing, the first recording medium 1 and the second recording medium 1 may be either identical or different. In the case where these are identical, the first information beam 301 and the second information beam 301 are identical, the first reference beam 302 and the second reference beam 302 are identical, the first pattern and the second pattern are identical, and the first main information and the second main information are identical. Conversely, in the case where the first recording medium 1 and the second recording medium 1 are different, these are generally different, respectively.

The details of components of the hologram recording/reproducing apparatus 2, and the details of recording operation and reproducing operation are as described above with reference to FIGS. 1, 2 and the like.

### EFFECT OF THIS EMBODIMENT

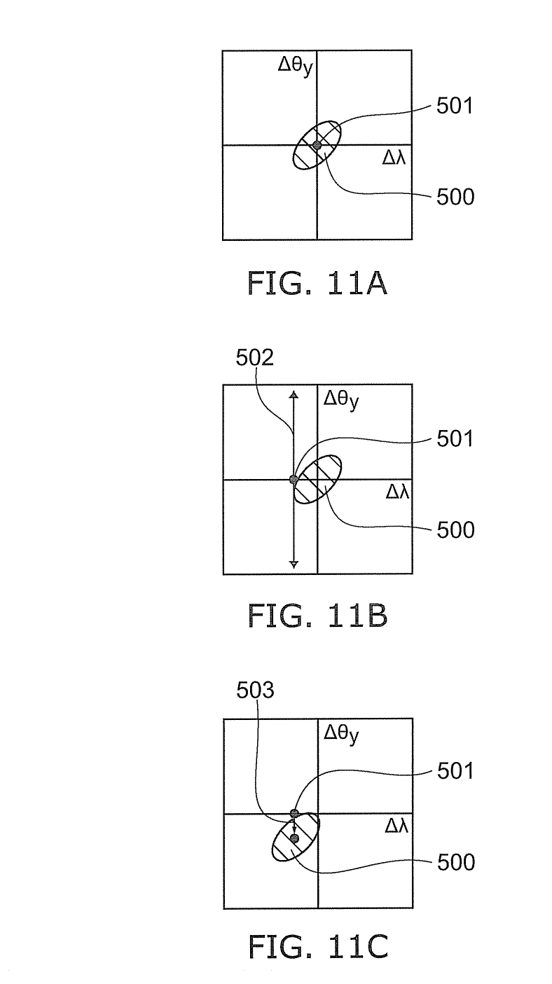

Next, the effect of this embodiment is described using a comparative example and a practical example with reference to FIGS. 11 to 16.

### Reproduced Image Intensity Map

First, the effect of this embodiment is conceptually described with reference to FIG. 11.

FIG. 11 shows schematic graphs for conceptually describing the hologram reproducing method (degraded reproduced image compensation method) according to this embodiment.

In FIG. 11, the horizontal axis represents the wavelength difference Δλ (=λ2−λ1) between the wavelength λ1 of the reference beam 302 and the wavelength λ2 of the reproduction illumination beam 402, and the vertical axis represents the difference Δθ_{y} (=θ_{P}−θ_{R}) between the incident angle θ_{R} of the reference beam 302 and the incident angle θ_{P} of the reproduction illumination beam 402. The graphs of FIG. 11 represent the reproduced image intensity in relation to these two parameters Δλ and Δθ_{y}. That is, they can be referred to as “reproduced image intensity maps”.

The hatched region in FIG. 11 represents a region with high reproduced image intensity. This will be referred to as “optimal region 500”. The bullet represents a combination of Δλ and Δθ_{y} which can be taken at the reproducing time. This will be referred to as “reproducing-time point 501”.

FIG. 11A shows a reproduced image intensity map in the case where the wavelength λ1 of the reference beam 302 is equal to the wavelength λ2 of the reproduction illumination beam 402. In such cases as there is no wavelength difference between the recording time and the reproducing time, the reproducing-time point 501 is located in the optimal region 500 even without compensation, that is, even if the reproducing-time point 501 is located at the position of Δλ=0 and Δθ_{y}=0. That is, the intensity of the reproduced image is appropriately ensured, enabling overall reproduction.

On the other hand, FIG. 11B shows a reproduced image intensity map in the case where the wavelength λ1 of the reference beam 302 and the wavelength λ2 of the reproduction illumination beam 402 are different. Here, the case of negative Δλ is shown. In such cases as there is any wavelength difference between the recording time and the reproducing time, the reproducing-time point 501 may fall outside the optimal region 500, and the intensity of the reproduced image may fail to be appropriately ensured. In this case, the reproducing-time point 501 can be moved along the vertical axis as shown by arrow 502 to adjust the value of Δθ_{y}. That is, the incident angle θ_{P} of the reproduction illumination beam 402 can be varied from the incident angle θ_{R} of the reference beam 302. However, as shown, in some cases, the reproducing-time point 501 cannot be moved into the optimal region 500 simply by such adjustment of Δθ_{y}, and overall reproduction may fail.

Thus, in this embodiment, compensation is performed by further using another parameter, temperature.

FIG. 11C shows a reproduced image intensity map in the case where the temperature of the recording medium 1 is varied between the recording time and the reproducing time. As shown, by varying the temperature of the recording medium 1, the optimal region 500 can be moved. In the figure, the optimal region 500 is moved to the negative side along both the horizontal axis and the vertical axis. Hence, as shown by arrow 503, the reproducing-time point 501 can be moved along the vertical axis so as to be located in the optimal region 500. That is, appropriate selection of the temperature variation ΔT and angle variation Δθ_{y} enables overall reproduction.

### Analysis Example

In the following, an analysis example of the reproduced image in the comparative example and the practical example is described.

The precondition for this analysis example is as follows.

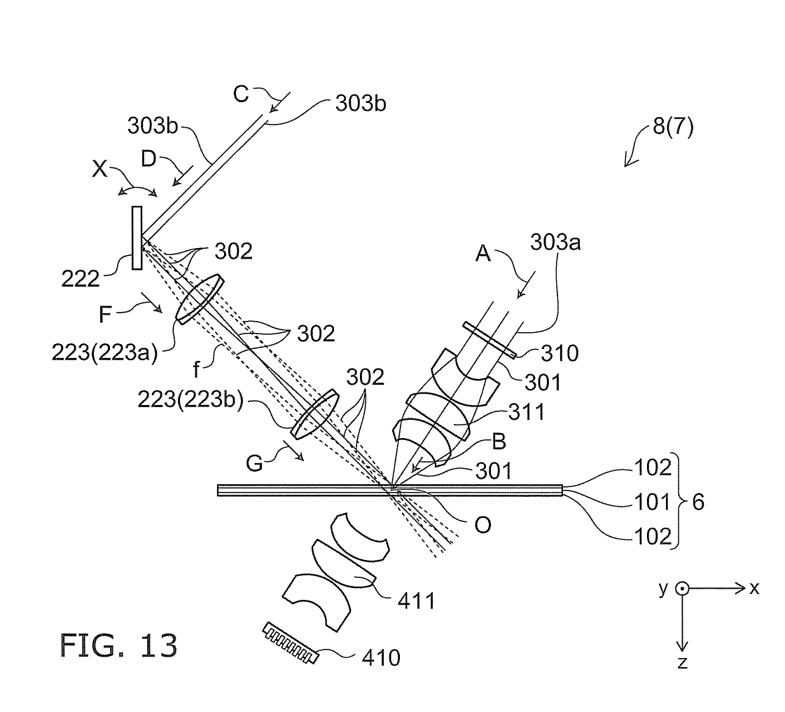

In this analysis example, two different hologram recording/reproducing apparatuses are used. Hologram recording/reproducing apparatuses 7A and 713 are used in the comparative example, and hologram recording/reproducing apparatuses 2A and 2B are used in the practical example. Here, the hologram recording/reproducing apparatuses 2A and 2B are similar to the hologram recording/reproducing apparatuses 2 illustrated in FIG. 1 except for the laser wavelength; and therefore, a drawing is omitted. The hologram recording/reproducing apparatuses 7A and 7B are similar to the hologram recording/reproducing apparatuses 7 illustrated in FIG. 13 except for the laser wavelength; and therefore, a drawing is omitted. In the hologram recording/reproducing apparatus 7A and the hologram recording/reproducing apparatus 2A, the laser wavelength (wavelength of the reference beam 302 and the reproduction illumination beam 402) is 405 nm, and in the hologram recording/reproducing apparatus 7B and the hologram recording/reproducing apparatus 2B, the laser wavelength (wavelength of the reference beam 302 and the reproduction illumination beam 402) is 404 nm. Here, a wavelength-tunable laser is not used, because it is not readily subjected to optical adjustment and wavelength control, and has such difficulties as being impossible to greatly vary the wavelength.

It is assumed that the apparatus temperature is controlled to be constant at 25° C. during both the recording time and reproducing time. Thus, the temperature of the recording medium 6 mounted on the hologram recording/reproducing apparatuses 7A and 7B and the temperature of the recording medium 1 mounted on the hologram recording/reproducing apparatuses 2A and 2B are also controlled at 25° C.

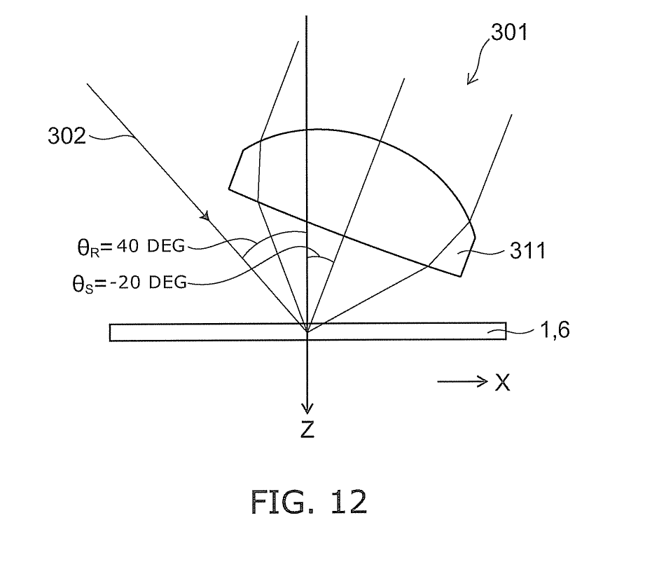

FIG. 12 is a schematic cross-sectional view showing an optical system used in this analysis example.

As shown in FIG. 12, angles occurring in the optical system are as follows. The incident angle θ_{S} of the information beam 301 in air is −20 degrees, the incident angle θ_{R} of the reference beam 302 in air is 40 degrees, the incident angle Θ_{S,in} of the innermost ray of the information beam 301 in the recording layer 101 is 13.1 degrees, the incident angle Θ_{S,out} of the outermost ray of the information beam 301 in the recording layer 101 is −34.2 degrees, and the incident angle Θ_{R} of the reference beam 302 in the recording layer 101 is 24.5 degrees. The numerical aperture (NA) of the objective lens 311 is 0.65, and a multi-group lens is used to reduce the field curvature and ensure the working distance.

With regard to the recording medium 6 and the recording medium 1, the recording layer 101 is made of a photopolymer, and the substrate 102 is made of a polycarbonate. Physical property values of the recording layer 101 are as follows: linear expansion coefficient γₓ=7.0×10⁻⁶, linear expansion coefficient γ_{z}=2.0×10⁻⁴, and refractive index n=1.55. The thickness of the recording medium 6 and the recording medium 1 is 1 mm each.

With regard to recorded data, at the recording time, the data is encoded into two-dimensional binary data and recorded on the recording medium 6 or the recording medium 1. At the reproducing time, this two-dimensional binary data is obtained by the imaging device 410, and the obtained image is decoded to recover the original data.

Under the foregoing precondition, the comparative example and the practical example were analyzed.

### Comparative Example

FIG. 13 is a schematic cross-sectional view illustrating the operation at the recording time of the hologram recording/reproducing apparatus 7 according to the comparative example, which is compared with this embodiment. That is, FIG. 13 illustrates the operation of a hologram recording apparatus 8 included in the hologram recording/reproducing apparatus 7.

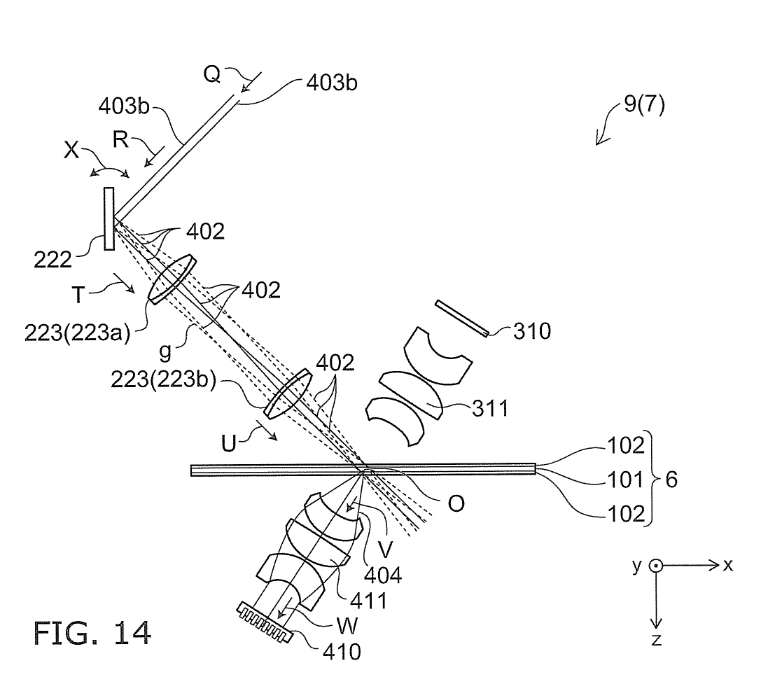

FIG. 14 is a schematic cross-sectional view illustrating the operation at the reproducing time of the hologram recording/reproducing apparatus 7 according to the comparative example. That is, FIG. 14 illustrates the operation of a hologram reproducing apparatus 9 included in the hologram recording/reproducing apparatus 7.

As shown in FIG. 13, the hologram recording apparatus 8 according to the comparative example does not include the device for writing the information of the wavelength of the reference beam 302 on the recording medium 6, such as the wavelength sensing device 230 and the encoder 331 shown in FIG. 1

Furthermore, as shown in FIG. 14, the hologram reproducing apparatus 9 according to the comparative example does not include the device for obtaining the information of the wavelength of the reference beam 302 from the recording medium 6 and using this information to control the temperature of the recording medium 6 and the incident angle of the reproduction illumination beam 402, such as the controller 260, the temperature control circuit 241, the temperature sensor 240, the temperature adjustment device 242, and the incident angle control circuit 251 shown in FIG. 1.

Hence, as shown in FIGS. 13 and 14, in the comparative example, the information of the wavelength of the reference beam 302 is not recorded on the recording medium 6 at the recording time, and the temperature of the recording medium 6 or the incident angle of the reproduction illumination beam 402 is not controlled using such information at the reproducing time.

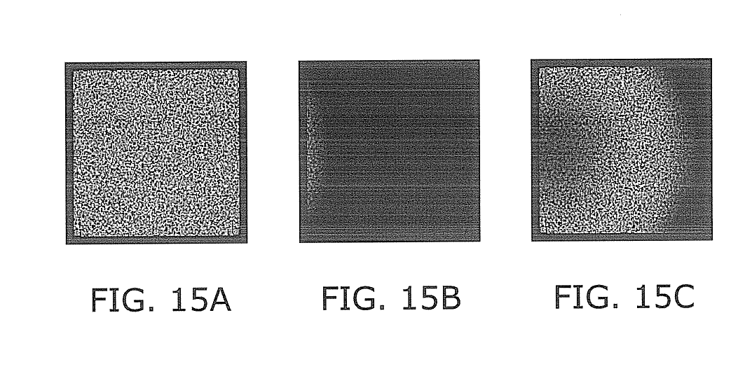

In the following, an analysis result in the comparative example is described with reference to FIG. 15.

FIGS. 15A to 15C are schematic views showing the analysis result of reproduced images in the case of using the hologram recording/reproducing apparatus 7 (hologram recording apparatus 8 and hologram reproducing apparatus 9) according to the comparative example. As shown, the images are each a binary pattern of bright and dark spots.

FIG. 15A shows an image formed by recording hologram information using the hologram recording/reproducing apparatus 7A and reproducing the hologram information using the same recording/reproducing apparatus 7A. In this case, the image is reproduced favorably. This is presumably because the wavelength of the reference beam 302 at the recording time and the wavelength of the reproduction illumination beam 402 at the reproducing time are equal, and the temperature of the recording medium 6 is kept constant.

Next, the recording medium 6 recorded by the hologram recording/reproducing apparatus 7A is replayed by the hologram recording/reproducing apparatus 7B. In this case, presumably, degradation of the image can be prevented by controlling the temperature so that the temperature is not significantly varied between the recording time and the reproducing time. However, even if the temperature is kept constant, the image may be degraded if the optical environment, such as the laser wavelength, is different for each apparatus. In this analysis example, the laser wavelength differs between the hologram recording/reproducing apparatus 7A and the hologram recording/reproducing apparatus 7B, and the image may be degraded.

FIG. 15B shows an image formed when the recording medium 6 recorded by the hologram recording/reproducing apparatus 7A is transferred to the hologram recording/reproducing apparatus 7B and replayed without any image compensation. In this case, it is found that the image is degraded. Although the temperature is kept constant between the recording time and the reproducing time, the wavelength of the reference beam 302 at the recording time (405 nm) and the wavelength of the reproduction illumination beam 402 at the reproducing time (404 nm) are different. Hence, presumably, the Bragg condition satisfied at the recording time is not satisfied at the reproducing time, thereby causing image degradation.

It is known that the degraded image as shown in FIG. 15B can be improved by slightly varying the incident angle of the reproduction illumination beam 402 from the incident angle of the reference beam 302 (e.g., JP-A-2006-277873).

FIG. 15C shows an optimized image in which the incident angle θ_{P} of the reproduction illumination beam 402 is varied from the incident angle θ_{R} of the reference beam 302, that is, θ_{P}=θ_{R}+Δθ_{y}, so that the image intensity is maximized. Specifically, Δθ_{y}=0.1 degrees. In this case, although a certain improvement effect is observed, but the image has unevenness. In particular, the image is not appropriately reproduced in the right-side portion. Because the information beam 301 is converged by the objective lens 311, the incident angle is varied with the location of the ray. Hence, presumably, even if the angle of the reproduction illumination beam 402 is adjusted as appropriate, a region satisfying the initial Bragg condition coexists with a region not satisfying it, and such unevenness occurs. Thus, presumably, further compensation is needed for overall reproduction.

### Practical Example

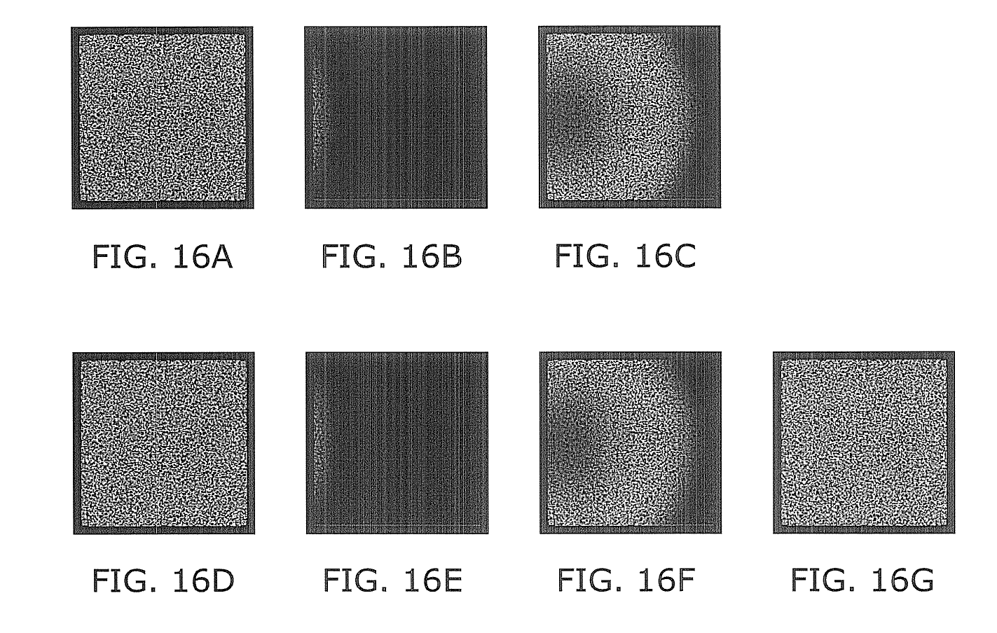

Next, an analysis result in the practical example according to this embodiment is described with reference to FIG. 16.

FIGS. 16A to 16G are schematic views showing the analysis result in the comparative example and the practical example. FIGS. 16A to 16C are the analysis result in the comparative example shown for comparison purposes, which are the same figures as FIGS. 15A to 15C. FIGS. 16D to 16G are schematic views showing the analysis result of reproduced images in the case of using the hologram recording/reproducing apparatus 2 (hologram recording apparatus 3 and hologram reproducing apparatus 4) according to this embodiment. As shown, the images are each a binary pattern of bright and dark spots.

FIG. 16D shows an image formed by recording hologram information using the hologram recording/reproducing apparatus 2A and reproducing the hologram information using the same hologram recording/reproducing apparatus 2A. In this case, the image is reproduced favorably. As described above with reference to FIG. 15A, this may be attributable to the fact the wavelength and temperature are the same between the recording time and the reproducing time.

FIG. 16E shows an image formed when the recording medium 1 recorded by the hologram recording/reproducing apparatus 2A is transferred to the hologram recording/reproducing apparatus 2B and replayed without any image compensation. In this case, like the image according to the comparative example shown in FIG. 16B, it is found that the image is degraded. This is presumably because, as described above with reference to FIG. 15B, although the temperature is kept constant between the recording time and the reproducing time, the wavelength of the reference beam 302 at the recording time (405 nm) and the wavelength of the reproduction illumination beam 402 at the reproducing time (404 nm) are different.

As described above, the degraded image as shown in FIG. 16E can be improved by slightly varying the incident angle of the reproduction illumination beam 402 from the incident angle of the reference beam 302.

FIG. 16F shows an optimized image in which the incident angle θ_{P} of the reproduction illumination beam 402 is varied from the incident angle θ_{R} of the reference beam 302, that is, θ_{P}=θ_{R}+Δθ_{y}, so that the image intensity is maximized. Specifically, Δθ_{y}=0.1 degrees. In this case, like the image according to the comparative example shown in FIG. 16C, although a certain improvement effect is observed, the image has unevenness and fails in overall reproduction.

On the other hand, FIG. 16G shows an image in which the control according to this embodiment is performed. More specifically, in the image shown, the temperature difference ΔT and the angle difference Δθ_{y} are determined on the basis of the difference Δλ (=λ1−λ2) between the wavelength λ1 of the reference beam 302 and the wavelength λ2 of the reproduction illumination beam 402, and used for compensation. The temperature difference ΔT is 3.4° C. (the temperature T2 at the reproducing time is 28.4° C.), and the angle difference Δθ_{y} is −0.12 degrees (the incident angle of the reproduction illumination beam 402 at the reproducing time is 39.88 degrees). These values are reasonably feasible. In this case, overall reproduction of the image is achieved as shown, and it is found that the image is reproduced favorably like the image shown in FIG. 16D. Thus, this embodiment can appropriately reproduce the recorded information.

In this practical example, the temperature at the recording time and the temperature at the reproducing time are equal. However, the temperature may vary depending on the operating environment. In such cases, in addition to the wavelength λ1 of the reference beam 302, the temperature T1 of the recording medium 1 at the recording time is also written in a prescribed region as described above so that these two data are obtained at the reproducing time. By this configuration, it is possible to construct a hologram recording/reproducing apparatus with higher robustness.

As described above, according to this embodiment, holographically recorded information can be reproduced favorably. Furthermore, in recording/reproduction, this effect can be achieved without overload on the mechanical system and the signal processing system.

The hologram recording apparatus 3, the hologram reproducing apparatus 4, and the hologram recording/reproducing apparatus 2 according to this embodiment can be suitably used for consumer products, and for archive systems such as in broadcasting, medical, governmental, and financial institutions. In the latter use such as in public institutions, an accurate temperature control mechanism requiring a large space, for instance, can be introduced so that information can be recorded/reproduced more favorably. The recorded information can include various information, such as document data and image data.

The embodiment of the invention has been described with reference to examples. However, the invention is not limited to these examples. That is, these examples can be suitably modified by those skilled in the art, and such modifications are also encompassed within the scope of the invention as long as they fall within the spirit of the invention. The components of the above examples and their layout, material, condition, shape, size, operation and the like are not limited to those illustrated, but can be suitably modified.

For instance, in the flow chart shown in FIGS. 7 and 9, the order of the steps may be interchanged within the spirit of this embodiment. For instance, in FIG. 7, step S33 for obtaining the wavelength of the reference beam 302 and step S34 for recording the information of the wavelength of the reference beam 302 on the recording medium 1 may follow step S35 for recording the main information on the recording medium 1. Furthermore, in FIG. 9, step S42 for obtaining the information of the wavelength λ1 of the reference beam 302 may follow step S43 for obtaining the information of the wavelength λ2 of the reproduction illumination beam 402.

The recorded information is not limited to binary data, but can be multivalued or other various data.

Furthermore, the components of the above embodiments can be combined as long as technically feasible, and such combinations are also encompassed within the scope of the invention as long as they fall within the spirit of the invention.

1. An optical information reproducing method comprising:
obtaining information about a wavelength of a reference beam at recording time from a recording medium which stores main information recorded as a pattern corresponding to interference between an information beam and the reference beam and information about the wavelength of the reference beam at the recording time;
determining an aiming temperature, which is a temperature of the recording medium suited to reproduce the pattern, on the basis of difference between the wavelength of the reference beam at the recording time and a wavelength of a reference beam at reproducing time;
determining an aiming incident angle, which is an incident angle of the reference beam at the reproducing time suited to reproduce the pattern, on the basis of the difference between the wavelength of the reference beam at the recording time and the wavelength of the reference beam at the reproducing time;
controlling the temperature of the recording medium so that the temperature of the recording medium is generally equal to the aiming temperature; and
controlling the incident angle of the reference beam at the reproducing time so that the incident angle of the reference beam at the reproducing time is generally equal to the aiming incident angle.

2. An optical information reproducing apparatus comprising:
an information obtaining device configured to obtain information about a wavelength of a reference beam at recording time from a recording medium which stores main information recorded as a pattern corresponding to interference between an information beam and the reference beam by a main information recording device and information about the wavelength of the reference beam at the recording time recorded by a wavelength information recording device;
a main information reproducing device configured to obtain the main information recorded on the recording medium by applying a reference beam at reproducing time;
a temperature determination device configured to determine an aiming temperature, which is a temperature of the recording medium suited to reproduce the pattern, on the basis of difference between the wavelength of the reference beam at the recording time and the wavelength of the reference beam at the reproducing time;
an incident angle determination device configured to determine an aiming incident angle, which is an incident angle of the reference beam at the reproducing time suited to reproduce the pattern, on the basis of the difference between the wavelength of the reference beam at the recording time and the wavelength of the reference beam at the reproducing time;
a temperature control device configured to control the temperature of the recording medium so that the temperature of the recording medium is generally equal to the aiming temperature; and
an incident angle control device configured to control the incident angle of the reference beam at the reproducing time so that the incident angle of the reference beam at the reproducing time is generally equal to the aiming incident angle.

3. The apparatus according to claim 2, further comprising:
a wavelength sensing device configured to sense the wavelength of the reference beam at the recording time.

4. The apparatus according to claim 2, further comprising:
a temperature information recording device configured to record information about the temperature of the recording medium at the recording time on the recording medium.

5. The apparatus according to claim 2, further comprising:
a wavelength sensing device configured to sense the wavelength of the reference beam at the reproducing time.

6. The apparatus according to claim 4, further comprising:
a wavelength sensing device configured to sense the wavelength of the reference beam at the reproducing time.

7. The apparatus according to claim 2, further comprising:
a device configured to obtain information of a reproducing temperature, which is a temperature of the recording medium at the reproducing time,
wherein the temperature determination device determines the aiming temperature by further using the reproducing temperature.

8. The apparatus according to claim 4, further comprising:
a device configured to obtain information of a reproducing temperature, which is a temperature of the recording medium at the reproducing time,
wherein the temperature determination device determines the aiming temperature by further using the reproducing temperature.

9. The apparatus according to claim 5, further comprising:
a device configured to obtain information of a reproducing temperature, which is a temperature of the recording medium at the reproducing time,
wherein the temperature determination device determines the aiming temperature by further using the reproducing temperature.

10. The apparatus according to claim 7, wherein the reproducing temperature is subjected to feedback control.

11. An optical information recording medium with data recorded thereon, the data comprising:
main information recorded as a pattern corresponding to interference between an information beam and a reference beam; and
information about a wavelength of the reference beam at recording of the main information.

12. The medium according to claim 11, wherein the information about the wavelength of the reference beam at the recording time is recorded in at least one of a lead-in region and a header region of the recording medium.

13. The medium according to claim 11, wherein information about temperature of the recording medium at the recording time is recorded.

14. The medium according to claim 12, wherein information about temperature of the recording medium at the recording time is further recorded in at least one of the lead-in region and the header region of the recording medium.

15. The medium according to claim 11, wherein the information about the wavelength of the reference beam at the recording time of the main information is recorded at lower resolution than the main information.

16. The medium according to claim 11, wherein the information about the wavelength of the reference beam at the recording time of the main information is recorded by angle-multiple recording.

17. The medium according to claim 11, wherein the information about the wavelength of the reference beam at the recording time of the main information is recorded by shift-multiple recording.

18. The medium according to claim 11, wherein the information about the wavelength of the reference beam at the recording time is recorded redundantly at different positions.

19. The medium according to claim 11, wherein the information about the wavelength of the reference beam at the recording time is recorded redundantly at different temperatures.

20. The medium according to claim 11, wherein a recording layer of the optical information recording medium includes a photo polymer.
